(19) United States
(12) Patent Application Publication
(10) Pub. No.: US 2026/0355030 A1
(43) Pub. Date: Nov. 12, 2026

(54) A DEVICE TO COUNTER THE EFFECT OF PATH CROSS-SLOPE ON MANUAL WHEELCHAIRS

(71) Applicants: Rory Christian Flemmer, Palmerston North (NZ); Claire Lorraine Flemmer, Palmerston North (NZ)

(72) Inventors: Rory Christian Flemmer, Palmerston North (NZ); Clair Lorraine Flemmer, Palmerston North (NZ)

(21) Appl. No.: 19/123,965

(22) PCT Filed: Oct. 25, 2023
(86) PCT No.: PCT/NZ2023/050112

§ 371 Date: Apr. 24, 2025

(30) Foreign Application Priority Data
Oct. 26, 2022 (NZ) 793760

(51) Int. Cl. A61G 5/06; A61G 5/10; B60B 33/00; B60B 33/02

(52) U.S. Cl. CPC A61G 5/06; A61G 5/10; B60B 33/0068; B60B 33/02

(57) ABSTRACT

The invention relates to ameliorating the disadvantage of a manual wheelchair when it traverses a sidewalk or pavement where, typically, the path slopes towards the street in order to shed rainwater and the wheelchair casters tend also to orient downward, requiring the user to put more effort into the downward rear wheel than the upward rear wheel. The invention relates to a device that may be installed on one or both casters of a wheelchair to bias the casters against the effect of the slope of the sidewalk.

### TECHNICAL FIELD

The invention relates to a device for a manual wheelchair which counters the effect of path slopes on the motion of the wheelchair.

### BACKGROUND TO THE INVENTION

Sidewalks and pavements typically slope toward the street, in order to shed rainwater. This is known as cross-slope. When traversing such sidewalks and pavements, this slope tends to cause the casters of a wheelchair to orient downward.

This is a common problem for users of manual wheelchairs. In order to counter cross-slope, it is necessary for the user to put more effort into propelling the downhill wheel more vigorously than the uphill wheel. This causes one arm to get more tired than the other.

### SUMMARY OF THE INVENTION

In a first aspect, the invention provides a device for biasing a caster operably attached to an object such that the caster is aligned with the intended direction of motion of the object, the caster having a caster shaft designed to rotate about a vertical axis, wherein the device comprises: a housing; a bearing configured to receive the caster shaft, such that the caster shaft can rotate about a substantially vertical axis but cannot move vertically or laterally; a cam fixed perpendicularly to the top of the caster shaft, such that turning the cam turns the shaft; a crank configured such that pulling a first end of the crank causes a second end of the crank to bear on the cam; and a pulling mechanism for pulling the first end of the crank, wherein the crank bears on the cam such that the caster is biased against turning away from the intended direction of motion.

The cam is so designed that, when the caster is pointing approximately in the direction of motion of the chair, then, when the crank applies a force upon the cam, the caster is biased to swivel in a direction. By applying a force to the crank, the user can bias the caster against the torque from the sloped path that tends to swivel the caster. This counters the inclination to swivel caused by the sloped path.

In an embodiment, the crank has a rotatable cam follower mounted on the second end to engage with the cam.

In an embodiment, the pulling mechanism comprises an elastic component, the elastic component connecting the first end of the crank to an anchoring point.

In an embodiment, the elastic component is a spring.

In an embodiment, the pulling mechanism can be engaged and disengaged, such that the crank constantly bears on the cam when the pulling mechanism is engaged.

In a second aspect, the invention provides a device for biasing a caster operably attached to an object such that the caster is aligned with the intended direction of motion of the object, the caster having a caster shaft designed to rotate about a vertical axis, wherein the device comprises: a housing; a bearing configured to receive a caster shaft attached to a caster; a cam fixed perpendicularly to the top of the caster shaft, such that turning the cam turns the shaft; a first crank, configured such that pulling a first end of the first crank causes a second end of the first crank to bear on the cam; a second crank, configured such that pulling a first end of the second crank causes a second end of the second crank to bear on the cam; and a pulling mechanism which selectively pulls either the first crank or the second crank, wherein, the crank bearing on the cam biases the caster against turning away from the intended direction of motion. In an embodiment, each crank has a rotatable cam follower mounted on the second end to engage with the cam.

In an embodiment, the first crank and second crank are configured to bear symmetrically on the cam.

In an embodiment, the pulling mechanism can be engaged to pull the first crank or the second crank, such that the pulled crank constantly bears on the cam until the pulling mechanism is disengaged.

In an embodiment, the pulling mechanism further comprises a first elastic component and a second elastic component, the first elastic component configured to pull the first end of the first crank and the second elastic component configured to pull the first end of the second crank.

In an embodiment, the elastic components are springs.

In an embodiment, the pulling mechanism comprises: an axle fixed to the housing; a first structure which rotates around the axle, wherein the first structure comprises a first anchoring point; a second structure which rotates around the axle, wherein the second structure comprises a second anchoring point; and connecting members which connect the first end of each respective crank to each respective anchoring point via each respective elastic component; wherein the device is configured such that at most one crank is engaged to bear on the cam at a time.

In an embodiment, the first structure comprises a first protrusion and the second structure comprises a second protrusion.

In an embodiment, the device further comprises a control mechanism, the control mechanism comprising an actuating end configured to rotate either the first structure or second structure by engaging either the first protrusion or the second protrusion.

In an embodiment, the control mechanism further comprises a controlling end which extends out of the housing, the mechanism configured such that when the controlling end is centred, neither the first crank nor the second crank is engaged, but moving the controlling end in a first direction from the centre engages the first crank and moving the controlling end from the centre in a second direction, opposite to the first direction, from the centre, engages the second crank, wherein the control mechanism is configured such that when the first crank is engaged, the degree to which the first crank bears on the cam is proportional to the distance between the controlling end and the centre in the first direction; and when the second crank is engaged, the degree to which the second crank bears on the cam is proportional to the distance between the controlling end and the centre in the second direction.

In an embodiment, the control mechanism is configured such that the controlling end can move in a third direction, and a fourth direction, opposite to the third direction.

In an embodiment, the controlling end is biased by an elastic component in a third direction.

In an embodiment, the control mechanism further comprises a stop configured such that when the controlling end is moved past the stop in one of the first direction or the second direction, the controlling end can move in the third direction to engage the stop, immobilizing the controlling end in at least one of the first direction or second direction.

In an embodiment, the device comprises, in each of the first and second directions, a first stop and a second stop, the first stop being closer to the centreline than the second stop and configured to retain the controlling end at an excursion to prevent movement of the controlling end in a first or second direction.

In an embodiment, each stop is configured to be adjustable.

In a third aspect, the invention provides a wheelchair comprising: a first caster fitted with a first device; and a second caster fitted with a second device; wherein the crank of the first device is configured to bear on the cam to bias the first caster in a first direction and the crank of the second device is configured to bear on the cam to bias the second caster in a second direction.

In a fourth aspect, the invention provides a wheelchair comprising at least one caster, wherein a caster is fitted with the device.

### BRIEF DESCRIPTION OF THE DRAWINGS

FIG. 1 shows a perspective view of one embodiment of the device for biasing a caster on a manual wheelchair;

FIG. 2 shows a perspective view of the device of FIG. 1, with the outer covers removed;

FIG. 3 shows a sectional view of the bearing housing and caster shaft.

FIG. 4 shows a sectional view of the clamping structure which receives the caster shaft.

FIG. 5 shows a perspective view of the cam plate, cam followers, the cranks, and the rotary members of the device.

FIG. 6 shows a perspective view of the cam plate.

FIG. 7 shows a perspective view of how the cranks are connected to the tension springs.

FIG. 8 shows a perspective view of the pulling mechanism.

FIG. 9 shows a perspective view of the mechanism for locking the control element.

### DETAILED DESCRIPTION

The present invention relates to a device that may be installed on either one or both casters of a wheelchair.

Wheelchairs typically comprise large drive wheels for propelling the wheelchair and smaller caster wheels for stability. The drive wheels are typically fixed to the body of the wheelchair such that they can only roll forward or back, around one axis. Casters are fixed such that they can both roll and swivel.

A standard caster structure comprises a caster wheel, which can rotate around an axle held between the prongs of a caster fork. The caster fork has a shaft which extends upward and is held by a bearing or bearings. The bearing(s) allows the shaft to rotate around a vertical axis but does not allow the shaft to move in any other way. The present invention is designed to be installed on such casters.

The bearing may alternatively be housed in the caster structure itself, and the shaft of the fork is rigidly fixed to the wheelchair. For such cases, another application of the central principle is required but this does not change the central principle.

The invention can be applied to either one or both of the casters of a wheelchair. If it is applied to only one caster, the nature of wheels dictates that the caster that is free to swivel will follow the caster that is controlled by the disclosed device. If two units are provided, one on each caster, then if it is desired, each caster may be biased in only one direction and either one or the other caster with a single such bias might be activated to control the cross-slope.

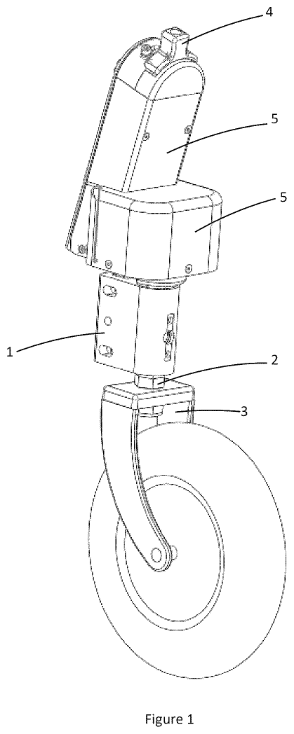

FIG. 1 shows the device, configured to engage with only one caster. A bearing housing 1 is attached to a typical wheelchair frame and has a caster shaft 2 rotatably fixed by bearings in this housing. The shaft 2 is rigidly attached to a set of caster forks 3. Incorporated in the device is a settable element 4 which can be used to control the action of the device. The internal operation of the device is shielded within covers 5.

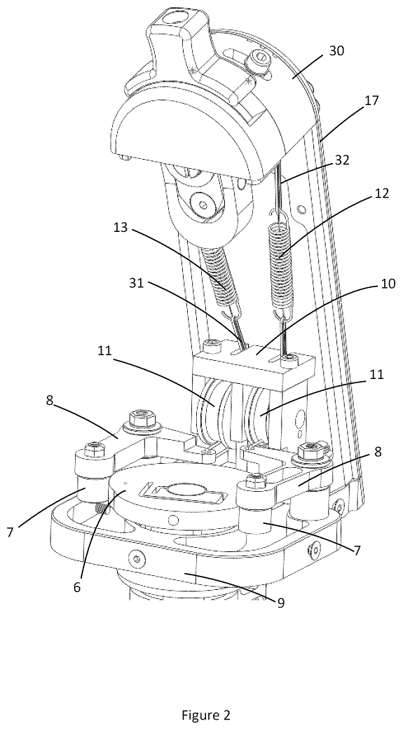

FIG. 2 shows the device with the covers removed. Rigidly affixed to the caster shaft 2 (FIG. 1) is a cam plate 6. Bearing on this cam plate are two rotary cam followers 7, mounted to the ends of bell cranks 8. The cam has a symmetrical profile so that the cam followers can bear on the cam symmetrically. The cam profile also has features which cooperate with the cam followers to allow the cam followers to effectively bear on the cam. The bell cranks are pivotally mounted to a base plate 9 so that they bear symmetrically on either side of the cam plate 6. To the ends of the other arms of the bell cranks are attached flexible elements 31 that are led around rotary elements such as pulleys 11, thereby having their axes of operation changed and aligned with tension springs 12 and 13, to which they are attached. In effect, when either of the tension springs is tensioned, the corresponding cam follower will bear on the cam plate and, depending on the orientation of the caster wheel, a torque may be engendered on the caster shaft 2 that would bias the caster wheel in a direction. The caster wheel can be biased in the opposite direction to the bias caused by the cross-slope, to counter the effect of cross-slope on the wheelchair. Obviously, the greater the extent to which the spring is stretched, the greater the bias applied to the caster shaft.

In another embodiment of the device, a single cam follower on a single bell crank is installed. This device can thus bias the caster in one direction, or release the bias.

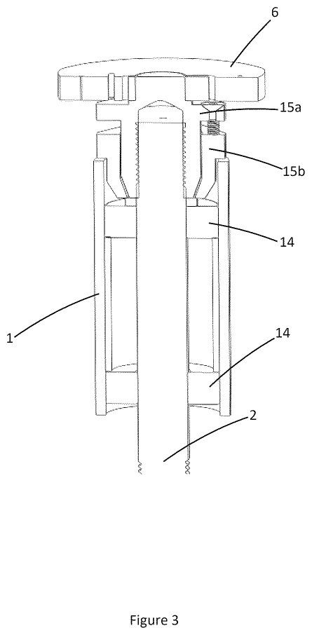

FIG. 3 shows a section through the bearing housing 1 and the caster shaft 2. The shaft is held in ball bearings 14, as is standard. In FIG. 3, the cam plate 6 is rigidly attached to a shaft clamping structure that has two parts 15a and 15b. This structure has the effect of rigidly and adjustably clamping the cam plate to the top of the caster shaft.

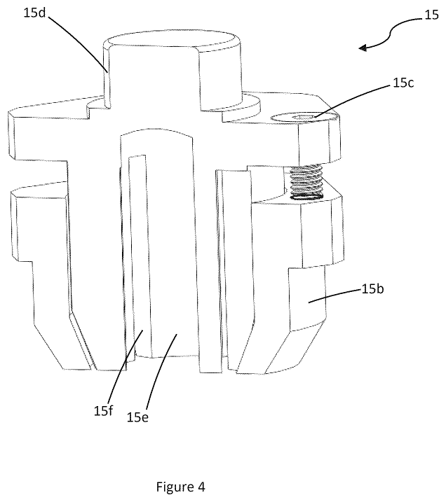

In FIG. 4, a section through the clamping structure 15 is shown. A central armature 15d carries a threaded cylindrical hole 15e, into which the caster shaft 2 can be screwed. The skirts of the central armature have a plurality of slots 15f so that when subjected to radial squeezing force, the skirts will “bite” on the thread of the caster shaft 2. A circular member 15b surrounds the central armature and has an internal tapered portion that engages with an external tapered portion of the central armature. When a plurality of screws 15c are tightened, the member 15b will slide over the tapered portion of the armature 15d, providing a radial squeezing force to the skirts. Thus, the clamping structure will be rigidly attached to the caster shaft 2.

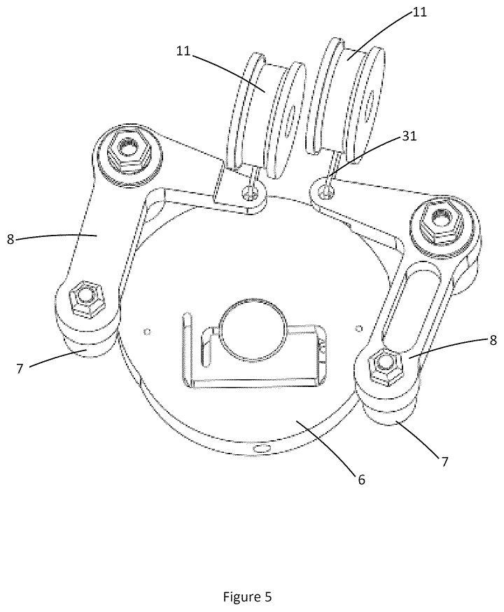

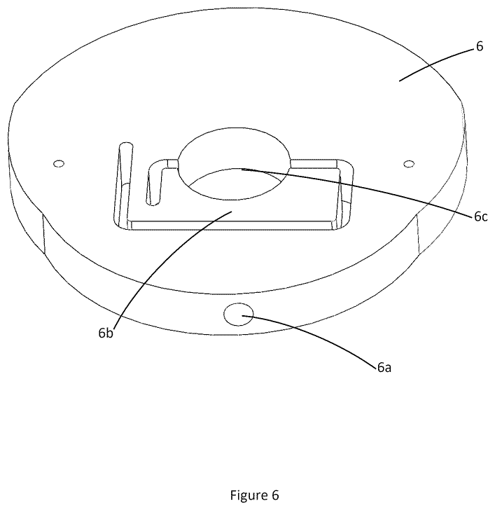

FIG. 5 shows cam plate 6 and the cam followers 7, attached to bell cranks 8. The bell cranks 8 are connected to springs 12 and 13 by flexible members such as a ropes, or cables. The flexible members 31 lead from the bell cranks and pass under the rotary members 11 and thence up to the springs 12 and 13 (FIG. 2). The cam plate has an arrangement of slots as shown in FIG. 6. It contains a threaded hole 6a into which can be screwed a setscrew which will bear upon section 6b. This will transfer force, moving section 6b and causing the aperture 6c to close about the cylindrical protrusion 15d of the central armature of the shaft clamping structure 15 (FIG. 4). In this way, the cam plate is rigidly attached to the caster shaft and thus the caster forks and the caster wheel.

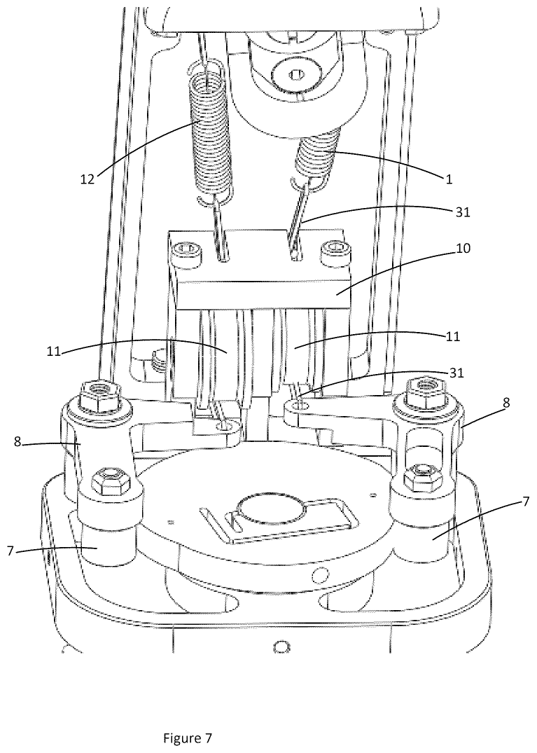

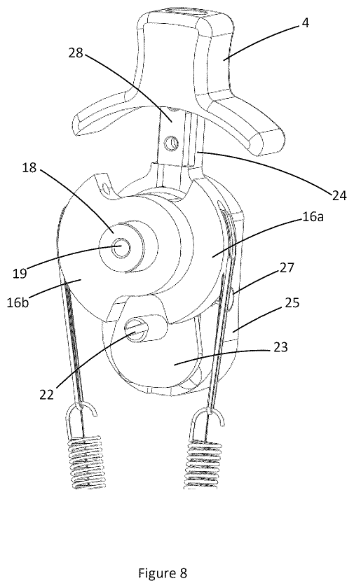

FIG. 7 shows the bell cranks 8 and cam followers 7 connected by flexible elements such as wire ropes to tension springs 12 and 13. Between each spring and rotary member 11, the flexible element 31 passes through slots in a wear plate 10. This serves to control the flexible elements and to prevent their sliding off the rotary members 11. If both springs are slackened, there is no biasing effect upon the caster. If either spring is tensioned, it acts upon the corresponding bell crank, cam follower and thus the cam plate. With a suitable profile for the cam plate and a suitable orientation of the caster, this biases the caster in a direction. The user of the manual wheelchair might traverse a path sloping down to the left or to the right and it is therefore advantageous for the user to be able to select one bias, or another, or neither, but not both. Accordingly, means are provided to tension one spring or the other or neither. This may be a pulling mechanism as shown in FIG. 8. At the upper end of each spring in FIG. 7, a flexible element such as a wire rope is attached and wound around and fixed to a quarter capstan 16a or 16b, as may be seen in FIG. 8. Methods of attachment, such as a hole in the capstan for the wire to be attached may also be appropriate.

The quarter capstans, in FIG. 8, pivot rotationally about a fixed axle 18. This is fixedly attached to a rigid back plate 17, by means of a bolt entering a threaded hole, 19. The quarter capstans 16a and 16b can rotate about this axle and because flexible elements 32 wind around them and are attached to them and attached at the other end to the springs, such rotation would tension one or other of the springs 12 or 13 (FIG. 7). The quarter capstans 16a and 16b are offset axially on the axle, one from the other as they rotate on the axle.

In FIG. 8, a rigid third member 23 is rotationally attached to the axle 18 and a peg 22 is fixedly attached to this member. The peg 22 moves through an arc of fixed radius, and remains parallel to the axle 18 when the control element is rotated about the axle. Therefore, rotation of the third member 23 about the axle 18 causes the peg 22 to engage with one or other of the capstans 16 to wind in the corresponding flexible element and consequently extend only one of the springs 12 or 13. This will bias the caster assembly one way or the other.

A fourth member 25 is pivotally mounted to the third member and can pivot about a pin 27 In this way, moving the fourth member in a first or second direction moves member 23 and thus one or other of the quarter capstans. Each end of the fourth member can also be brought closer to or further from the plane of rotation of the third member. Springs between the third and fourth members (not shown) bias the fourth member to approach the plane of the third member. The fourth member 25 has an extension 24 at the top end and to this is attached a control element 4. The user can therefore move the control element in two dimensions-about the axle 18 and in directions orthogonal to this motion.

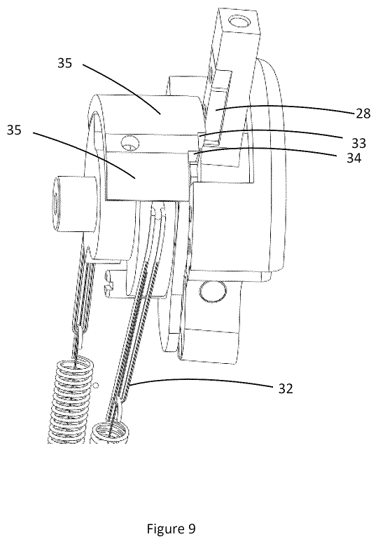

FIG. 9 shows how the orientation of the third member can be locked at the end of an excursion about the axle 18 (FIG. 8). A block 35 comprising stops 33 and 34 is rigidly mounted to the back plate 17 (FIG. 2). A hardened striker plate 28 is rigidly attached to the extension 24. The control element 4 can be moved back, pivoting about the pin 27, away from the stops and then turned about the axle 18. When it is released, the springs between the third member and the fourth member will cause the striker plate to approach the block 35. The control element may then be arrested against a nearer stop 33 or a further stop 34 and thereby extend the appropriate spring and therefore apply a lesser or a greater force to the corresponding cam follower as it rests on the cam.

When the control element is pulled backwards (moving the striker plate away from the block 35), the control element can adopt a central position, extending neither spring 12 nor 13.

The above description is by way of example only and modifications are possible without departing from the scope of the invention,

It will be appreciated that the above-described device is suitable for countering the effect of path cross-slope on manual wheelchairs, but can also be applied to other products whose motion is affected by cross-slope, provided such products comprise a caster having a caster shaft designed to rotate about a vertical axis. The term wheelchair in this specification should be read broadly enough to encompass such products.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated feature but not to preclude the presence or addition of further features in various embodiments of the invention.

1. A device for biasing a caster operably attached to an object, such that the caster is biased to be aligned with the intended direction of motion of the object, the caster having a caster shaft designed to rotate about a vertical axis, wherein the device comprises:
a housing;
a bearing configured to receive the caster shaft, such that the caster shaft can rotate about a substantially vertical axis but cannot move vertically or laterally;
a cam fixed perpendicularly to the top of the caster shaft, such that turning the cam turns the shaft;
a crank configured such that pulling a first end of the crank causes a second end of the crank to bear on the cam; and
a pulling mechanism for pulling the first end of the crank,
wherein the crank bears on the cam such that the caster is biased against turning away from the intended direction of motion.

2. The device of claim 1, wherein the crank has a rotatable cam follower mounted on the second end to engage with the cam.

3. The device of claim 1, wherein the pulling mechanism comprises an elastic component, the elastic component connecting the first end of the crank to an anchoring point.

4. (canceled)

5. The device of claim 1, wherein the pulling mechanism can be engaged and disengaged, such that the crank constantly bears on the cam when the pulling mechanism is engaged.

6. The device of claim 1, further comprising a second crank, wherein the second crank is configured such that pulling a first end of the second crank causes a second end of the second crank to bear on the cam in a second direction; and
wherein the pulling mechanism is configured to selectively pull either the first or second crank, causing the selected crank to bear on the cam such that the caster is biased against turning away from the intended direction of motion.

7. (canceled)

8. The device of claim 6, wherein the first crank and second crank are configured to bear symmetrically on the cam.

9. (canceled)

10. (canceled)

11. (canceled)

12. The device of claim 6 wherein the pulling mechanism comprises:
a first elastic component, configured to pull the first end of the first crank;
a second elastic component, configured to pull the first end of the second crank;
an axle fixed to the housing;
a first structure which rotates around the axle, wherein the first structure comprises a first anchoring point;
a second structure which rotates around the axle, wherein the second structure comprises a second anchoring point; and
connecting members which connect the first end of each respective crank to each respective anchoring point via each respective elastic component;
wherein the device is configured such that at most one crank is engaged to bear on the cam at a time.

13. The device of claim 12, wherein the first structure comprises a first protrusion and the second structure comprises a second protrusion, and wherein the device further comprises a control mechanism, the control mechanism comprising an actuating end configured to rotate either the first structure or second structure by engaging either the first protrusion or the second protrusion.

14. (canceled)

15. The device of claim 13, wherein the control mechanism further comprises a controlling end which extends out of the housing, the mechanism configured such that when the controlling end is centred, neither the first crank nor the second crank is engaged, but moving the controlling end in a first direction from the centre engages the first crank and moving the controlling end from the centre in a second direction, opposite to the first direction, from the centre, engages the second crank, wherein the control mechanism is configured such that when the first crank is engaged, the degree to which the first crank bears on the cam is proportional to the distance between the controlling end and the centre in the first direction; and
when the second crank is engaged, the degree to which the second crank bears on the cam is proportional to the distance between the controlling end and the centre in the second direction.

16. The device of claim 15, wherein the control mechanism is configured such that the controlling end can move in a third direction, and a fourth direction, opposite to the third direction; and wherein the controlling end is optionally biased by an elastic component in a third direction.

17. (canceled)

18. The device of claim 16, wherein the control mechanism further comprises a stop configured such that when the controlling end is moved past the stop in one of the first direction or the second direction, the controlling end can move in the third direction to engage the stop, immobilizing the controlling end in at least one of the first direction or second direction.

19. The device of claim 18, wherein the device comprises, in each of the first and second directions, a first stop and a second stop, the first stop being closer to the centreline than the second stop and configured to retain the controlling end at an excursion to prevent movement of the controlling end in the first direction or the second direction.

20. The device of claim 18, wherein each stop is configured to be adjustable.

21. A wheelchair comprising:
a first caster fitted with a first device of claim 1; and
a second caster fitted with a second device of claim 1;
wherein the crank of the first device is configured to bear on the cam in a first direction and the crank of the second device is configured to bear on the cam in a second direction.

22. A wheelchair comprising at least one caster, wherein the caster is fitted with the device of claim 6.
